(19) United States
(12) Patent Application Publication
(10) Pub. No.: US 2013/0044773 A1
(43) Pub. Date: Feb. 21, 2013

(54) OPTICAL SOURCES HAVING PROXIMITY COUPLED LASER SOURCE AND WAVEGUIDE

(71) Applicants: Venkata Adiseshaiah Bhagavatula, Big Flats, NY (US); Jacques Gollier, Painted Post, NY (US); Dmitri Vladislavovich Kuksenkov, Big Flats, NY (US)

(72) Inventors: Venkata Adiseshaiah Bhagavatula, Big Flats, NY (US); Jacques Gollier, Painted Post, NY (US); Dmitri Vladislavovich Kuksenkov, Big Flats, NY (US)

(21) Appl. No.: 13/212,734

(22) Filed: Aug. 18, 2011

(51) Int. Cl. H01S 3/10; H01S 3/08

(52) U.S. Cl. 372/22; 372/108

(57) ABSTRACT

An optical source including a laser source and a waveguide is provided. The laser source includes a laser cavity having a laser optical path length extending from a DBR grating to a reflective laser output facet, and emits an output beam at a fundamental wavelength. The waveguide has an input facet and an output facet, and extends along a waveguide optical length from the input facet of the waveguide to the output facet of the waveguide. The input facet and the output facet of the waveguide are approximately normal with respect to an optical path of the output beam. The waveguide and the laser source are proximity coupled, and the waveguide optical length is an integer multiple of the laser optical path length.

### BACKGROUND

### Field

Embodiments of the present disclosure generally relate to optical sources and, more particularly, optical sources comprising a proximity-coupled laser source and waveguide for optical feedback control.

### SUMMARY

Although the various concepts of the present disclosure are not limited to lasers that operate in any particular part of the optical spectrum, reference is frequently made herein to frequency-doubled green lasers, where wavelength fluctuations of the diode IR source typically generate fluctuations of the frequency-converted green output power. Such fluctuations are often attributable to the relatively narrow spectral acceptance curve of the wavelength conversion device used in the frequency-converted laser—typically a periodically poled lithium niobate (PPLN) SHG crystal. If the aforementioned frequency-converted laser is used in a scanning projector, for example, the power fluctuations can generate unacceptable image artifacts. For the specific case when the laser comprises a two or three-section DBR laser, the laser cavity is defined by a relatively high reflectivity Bragg mirror on one side of the laser chip and a relatively low reflectivity coating on the other side of the laser chip. The resulting round-trip loss curve for such a configuration is proportional to the inverse of the spectral reflectivity curve of the Bragg mirror. Also, only a discrete number of wavelengths called cavity modes can be selected by the laser. As the chip is operated, its temperature and therefore the refractive index of the semiconductor material changes, shifting the cavity modes relative to the Bragg reflection curve. As soon as the currently dominant cavity mode moves too far from the peak of the Bragg reflection curve, the laser switches to the mode that is closest to the peak of the Bragg reflection curve since this mode corresponds to the lowest loss—a phenomenon known as mode hopping.

Mode hopping can create sudden changes in output power and will often create visible borders between slightly lighter and slightly darker areas of a projected image because mode hops tend to occur at specific locations within the projected image. Sometimes, a laser will continue to emit in a specific cavity mode even when it moves away from the Bragg reflection peak by more than one free spectral range (mode spacing)—a phenomenon likely related to spatial hole burning and electron-photon dynamics in the cavity. This results in a mode hop of two or more cavity mode spacings and a corresponding unacceptably large change in output power.

Optical feedback from the SHG crystal may create laser wavelength instability in the DBR laser. One method to limit the effect of optical feedback may be to wedge the input and/or output facets of the SHG crystal such that the beam produced by the DBR laser is not perpendicular to the input and/or output facets. However, the wedged facets may need to be orientated at a certain angle with respect to the optical axis of the system, which may add mechanical design constraints as symmetric designs may be desired to obtain increased stability. Even when the facets are wedged at a large angle, the present inventors have recognized that parasitic reflections from the SHG front facet may significantly affect the laser wavelength stability. According to the subject matter of the present disclosure, configurations and corresponding methods of operation are provided to address these and other types of power variations in frequency-converted optical sources.

In accordance with one embodiment, an optical source includes a laser source and a waveguide. The laser source includes a laser cavity having a laser optical path length extending from a DBR grating to a reflective laser output facet, and emits an output beam at a fundamental wavelength. The waveguide has an input facet and an output facet, and extends along a waveguide optical length from the input facet of the waveguide to the output facet of the waveguide. The input facet and the output facet of the waveguide are approximately normal with respect to an optical path of the output beam. The waveguide and the laser source are proximity coupled, and the waveguide optical length is an integer multiple of the laser optical path length.

In accordance with another embodiment, an optical source includes a laser source and a wavelength conversion device. The laser source includes a laser cavity having a laser optical path length extending from a DBR grating to a reflective laser output facet, and emits an output beam at a fundamental wavelength. The wavelength conversion device has an input facet, an output facet, and a waveguide extending from the input facet of the wavelength conversion device to the output facet of the wavelength conversion device. The input facet and the output facet of the wavelength conversion device are approximately normal with respect to the optical path of the output beam. The output facet of the wavelength conversion device has a reflectivity that is higher than a reflectivity of the reflective laser output facet of the laser source. The wavelength conversion device and the laser source are proximity coupled. A wavelength conversion device optical length extending along the waveguide is an integer multiple of the laser optical path length. The wavelength conversion device converts the output beam emitted by the laser source into a frequency-converted output beam having a converted wavelength that is shorter than the fundamental wavelength.

In accordance with yet another embodiment, an optical source includes a laser source and a wavelength conversion device. The laser source includes a laser cavity having a laser optical path length extending from a DBR grating to a reflective laser output facet, and emits an output beam at a fundamental wavelength. The wavelength conversion device has an input facet, an output facet, and a waveguide extending from the input facet of the wavelength conversion device to the output facet of the wavelength conversion device. The input facet and the output facet of the wavelength conversion device are approximately normal with respect to the optical path of the output beam. The reflective laser output facet, the input facet of the wavelength conversion device, and the output facet of the wavelength conversion device have a reflectivity such that R₃>R₁+R₂+2(R₁*R₂)^{0.5}, where R₁ is a reflectivity of the reflective laser output facet of the laser source, R₂ is a reflectivity of the input facet of the waveguide, and R₃ is a reflectivity of the output facet of the waveguide. The wavelength conversion device and the laser source are proximity coupled. The wavelength conversion device optical length extending along the waveguide is an integer multiple of the laser optical path length. The wavelength conversion device converts the output beam emitted by the laser source into a frequency-converted output beam having a converted wavelength that is shorter than the fundamental wavelength.

### BRIEF DESCRIPTION OF THE DRAWINGS

FIG. 1 is a schematic illustration of an optical source comprising a DBR laser diode and a proximity-coupled wavelength conversion device that define an external cavity according to one or more embodiments of the present disclosure;

FIG. 2 illustrates a round trip extended cavity spectral reflection curve of a laser system in a non-cavity matched condition;

FIG. 3 illustrates a round trip extended cavity spectral reflection curve of an optical source in a cavity matching condition according to one or more embodiments of the present disclosure;

FIG. 4 is a plot of the wavelength standard deviation versus IR wavelength as the gain current increased for a cavity matching condition and non-cavity matching conditions; and

FIG. 5 is a plot of the wavelength of the extended cavity mode with the highest round trip reflectivity as a function of the diode cavity resonance shift according to one or more embodiments of the present disclosure.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts.

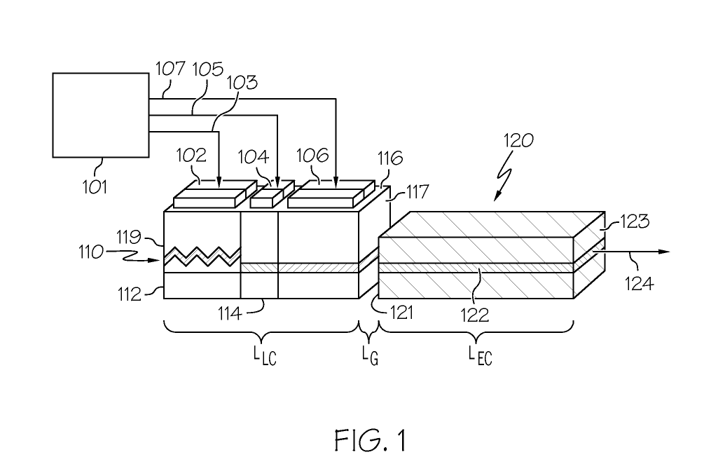

Referring initially to FIG. 1, according to one embodiment of the present disclosure, an optical source 100 comprises a laser cavity presented in the form of a DBR laser diode 110, and a wavelength conversion device presented as a waveguide PPLN crystal 120. Although the present disclosure discusses the particular case where the optical source 100 comprises a laser source configured as a three-section DBR laser diode 110, which is used as an IR pump source, and a waveguide PPLN crystal 120, which is used for frequency doubling into the green wavelength range, it is noted that the concepts of the present disclosure are equally applicable to a variety of frequency-converted laser configurations including, but not limited to, configurations that utilize frequency conversion beyond second harmonic generation (SHG). The concepts of the present disclosure are also applicable to a variety of applications in addition to laser scanning projectors.

The DBR laser diode 110 defines a laser cavity comprising a gain section 116, a phase section 114, and a wavelength selective DBR section 112 interposed between a relatively high reflectivity rear laser facet 119 and a relatively low reflectivity laser output facet 117 at the output of the DBR laser diode 110. The laser cavity defined by the DBR laser diode 110 provides an optical path length L_{LC} of light propagating therein, which is the effective laser cavity length. It should be understood that throughout the figures the optical path length L_{LC} of the laser cavity is labeled as the length of the DBR laser diode 110 for illustrative purposes only, and that the optical path length L_{LC} of the laser cavity is the optical distance of light traveling therein, and may or may not be equal to the physical length of the DBR laser diode 110, and also may be altered by the control signals to the DBR laser diode 110.

Respective control electrodes 102, 104, 106, may be incorporated in the wavelength selective DBR section 112, the phase section 114, the gain section 116, or combinations thereof, and are merely illustrated schematically in FIG. 1. The control electrodes may be electrically coupled to a laser controller 101, which may be configured to provide a wavelength selective modulation signal 103, a phase modulation signal 105, and a gain modulation signal 107 to the wavelength selective section 112, the phase section 114, and the gain section 116, respectively. The controller 101 may comprise any number of hardware and software components to generate the modulation signals 103, 105, 107. It is contemplated that the control electrodes 102, 104, 106 may take a variety of forms. For example, the control electrodes 102, 104, 106 are illustrated in FIG. 1 as respective electrode pairs but it is contemplated that single electrode elements 102, 104, 106 in one or more of the sections 112, 114, 116 will also be suitable for practicing particular embodiments of the present disclosure. The control electrodes 102, 104, 106 can be used to inject electrical current into the corresponding sections 112, 114, 116 of the DBR laser diode 110. The injected current can be used to alter the operating properties of the laser by, for example, controlling the temperature of one or more of the laser sections, injecting electrical current into a conductively doped semiconductor region defined in the laser substrate, controlling the index of refraction of the wavelength selective DBR and phase sections 112, 114 of the DBR laser diode 110, controlling optical gain in the gain section 116, etc.

In one embodiment, the wavelength conversion device 120 comprises an SHG crystal having a frequency-converting waveguide 122 that extends from an input facet 121 to an output facet 123. As illustrated in FIG. 1, the input facet 121 of the wavelength conversion device 120 is optically coupled to the DBR laser diode 110 by proximity coupling. For the purposes of describing and defining the present disclosure, it is noted that a laser source can be considered to be “proximity-coupled” to a wavelength conversion device when the proximity of the output face of the laser source and the input face of the wavelength conversion device is the primary mechanism for coupling an optical signal from the laser source into the waveguide of the wavelength conversion device. Typical proximity-coupled packages will not employ collimating, focusing, or other types of coupling optics in the optical path between the laser source and the wavelength conversion device, although it is contemplated that some proximity-coupled packages may employ relatively insignificant optical elements between the laser and wavelength conversion device, such as optical films, protective elements, correction lenses, optical filters, optical diffusers, etc. In any case, for proximity-coupled packages, it is contemplated that the proximity of the laser and the wavelength conversion device will be responsible for at least 30% of the optical intensity coupled from the laser to the wavelength conversion device.

The waveguide 122 may be periodically poled to achieve quasi-phase matching to frequency-double an IR output beam emitted by the DBR laser diode 110. A frequency-converted output beam 124, which has a converted wavelength that is shorter than the wavelength of the IR output beam, is then emitted from the output facet 123 of the wavelength conversion device 120. In one embodiment, the frequency-converted output beam 124 has a wavelength that is in the green spectral range.

Although the waveguide 122 is illustrated as being a component of an SHG crystal, embodiments are not limited thereto. For example, the waveguide 122 may be incorporated into an optical fiber or other optical component.

The input facet 121 and/or output facet 123 of the wavelength conversion device 120 may be reflective such that portions of the IR beam emitted by the DBR laser diode 110 are reflected back into the laser. The output facet 123 of the wavelength conversion device may define an external cavity that may function as a Fabry-Perot cavity having an optical path length extending L_{EC} from the reflective laser output facet 117 to the output facet 123 of the wavelength conversion device, depending on the reflectivity of the input and output facets 121, 123 of the wavelength conversion device 120. In one embodiment, the input facet 121 and the output facet 123 of the wavelength conversion device are normal with respect to the optical path of the IR beam and the frequency-converted output beam 124 (i.e., the input and output facets of the wavelength conversion device are straight facets).

A portion of the light from the laser cavity of the DBR laser diode 110 is emitted through the laser output face 117 and coupled to the wavelength conversion device 120, while the remaining light bounces back and forth in the laser cavity between the DBR grating, which acts as a mirror, and the laser output facet 117, each time passing through the gain medium of the gain section 116. Additionally, back reflections of light may be reflected from the input facet 121 and or the output facet 123 of the wavelength conversion device and re-enter the laser cavity. These back reflections may cause wavelength instability of the DBR laser diode 110, as well as the resulting frequency-converted output beam 124 emitted from the wavelength conversion device 120.

As described above, the cavity of a DBR laser may be closed by the grating of the wavelength selective DBR section on one side and the reflectivity of the laser output facet on the other side. The round-trip spectral gain curve may be expressed as:

RTG(λ)=G·DBR(λ)·R_{ff}, Eq. (1),

where RTG(λ) is the round-trip gain, G is the gain section gain coefficient, and R_{ff} is the laser front facet reflectivity. To determine the wavelength selected by the laser, the cavity modes may be calculated. The cavity modes of the laser diode are the wavelengths where the optical path over a round trip with in the laser cavity equals an integer times the wavelength. The cavity modes are calculated by determining the wavelengths that can create standing waves, i.e. wavelengths where there is a round trip light wave phase change of 2π. The wavelength emitted by the DBR laser diode is then given by the cavity mode that is closest to the RTG spectral curve. The wavelength difference between the various modes may be expressed as:

$$Δλ = \frac{{λ}^{2}}{2 \cdot L \cdot n} , \qquad Eq . ( 2 )$$

where L is the laser diode length, and n is the index of refraction of gallium arsenide (GaAs).

As an example and not a limitation, with a laser cavity physical length of 3 mm, mode spacing is about 0.06 nm. The expectation is then that the maximum wavelength fluctuations should be about ±0.03 nm, which would result in frequency-converted power fluctuations of about 4% when assuming a 0.24 bandwidth PPLN crystal as the wavelength conversion device. However, the present inventors have recognized that measured power fluctuations are much larger, and experimental results suggest that part of the wavelength fluctuations is due to instabilities induced by parasitic reflections on the input facet and/or output facet of the wavelength conversion device.

In one experiment, which consisted of generating variable amounts of back reflection from a wavelength conversion device and applying increasing gain current, about −110 dB of feedback resulted in a DBR laser diode that operated normally. The level of feedback was increased from about −110 dB to about −3 dB of back reflections. At −70 dB, some abnormal mode hops were discovered at low current. At −40 dB, abnormal mode hops were spread everywhere throughout the current range. The mode hop structure appeared to disappear at −18 dB and was replaced by smoother transitions. Finally, at −3 dB of feedback, the normal expected curve shape of the IR wavelength was totally disturbed and very large amplitude wavelength variations were evident. Accordingly, back reflections into the laser cavity may increase wavelength instability.

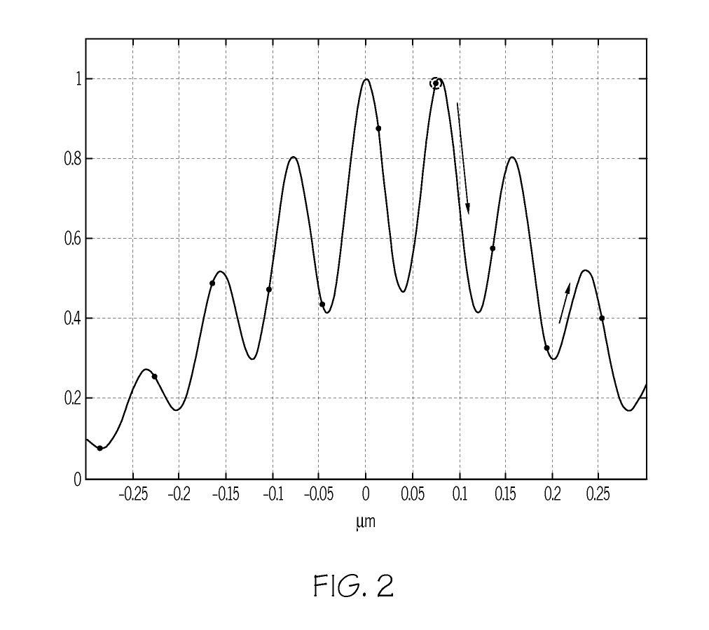

FIG. 2 graphically illustrates one example of a round trip extended cavity spectral reflection curve. For completeness, it is noted that the curve of FIG. 2 has been normalized such that the maximum reflection is equal to 1.0. Referring additionally to FIG. 1, it is noted that the curve of FIG. 2 was obtained using a wavelength selective DBR section 112 having a full width half maximum (FWHM) spectral bandwidth of 0.6 nm, an external reflector reflectivity of 2.5% (e.g., an input facet of a wavelength conversion device), a laser cavity length of 3 mm, and an extended cavity length between the laser output facet 117 and the external reflector of 7 mm. The points on the curve correspond to particular cavity modes. In the case where the external mirror has a reflection coefficient smaller than the laser output facet, it may be shown that the mode spacing remains close to the mode without the external reflector. In the optical source depicted in FIG. 1, the external reflector may be considered as the output facet 123 of the waveguide 122/wavelength conversion device 120. Additionally, the period of the modulation is dictated by the distance between the laser output facet 117 and the external mirror defined by the output facet 123 of the waveguide 122. When that distance is different from the laser round trip optical path, the mode spacing and the modulation period are both different.

As illustrated in FIG. 2, the encircled point corresponds to the mode currently selected by the DBR laser diode. When the effective length of the laser cavity is changed by modulating the gain signal, the curve in FIG. 2 will stay in place. However, as the DBR laser diode heats up due to gain current modulation, the cavity modes shift to the right. The selected mode may rapidly fall in a minimum of modulation to the closest cavity mode as indicated by the arrows. The points in the figure may move up or move down the sloping portions of the curve. Another mode located far way from the maximum of the DBR curve can move towards a maximum of the modulation and be selected although it is located far away from the DBR maximum. In the illustrated case, the amplitude of the wavelength fluctuations can end up being much larger than ±0.03 nm.

Additionally, the modulation frequency increases as the distance of the external reflective surface from the DBR laser diode increases. The consequence is that the DBR laser diode may become unstable and start mode hopping very often. Accordingly, simulations and experimentation suggest that feedback as low as 0.01% may be enough to create laser instabilities. Even with wedged and anti-reflective (AR) coated crystals, such reflectivity levels may be difficult to achieve.

The present inventors have recognized that when the external reflective surface (e.g., the output facet 123 of the waveguide 122/wavelength conversion device 120 depicted in FIG. 1) is substantially the same as the optical path of the laser cavity (i.e., a cavity matching condition), the period of the gain curve modulation is substantially the same as the cavity mode inter-distance.

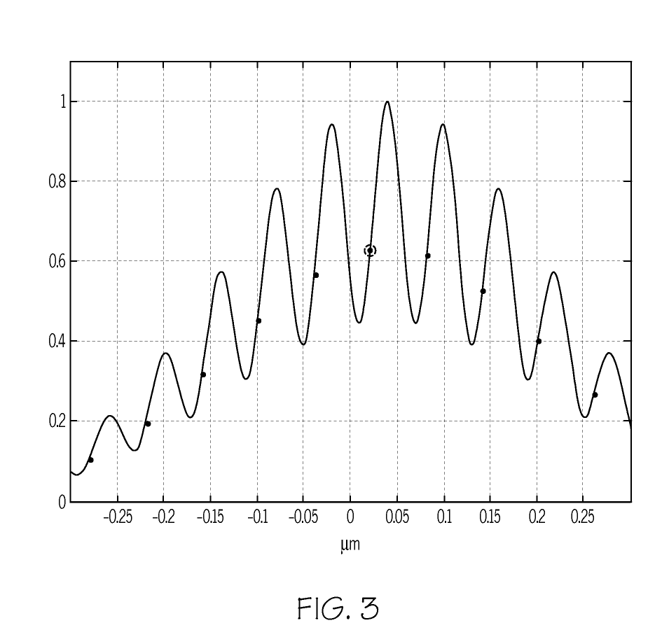

FIG. 3 depicts a graph illustrating the round trip extended cavity spectral reflection curve of an optical source according to one embodiment wherein the DBR laser diode 110 and the output facet 123 of the wavelength conversion device 120 is in a cavity matching condition (see FIG. 1). For example, as illustrated in FIG. 1 and described in detail below, a cavity matching condition may be present when the waveguide 122 of the wavelength conversion device 120 is proximity coupled to the laser output facet 117 and the length of the waveguide 122 is an integer multiple of the optical path length L_{LC} of the laser cavity.

As with FIG. 2, the points in the graph of FIG. 3 represent cavity modes, with the encircled point being the currently selected cavity mode. The modulation of the gain curve due to injection of gain current and/or heating of the DBR laser diode 110 does not affect the relative gains between the modes. In other words, when the modes are moving, they are all located at substantially the same position on the modulation and the curve that is joining the points has the same shape as the DBR curve alone. Accordingly, the modes are going to be selected exactly like there was no external cavity presented at all. Therefore, when the laser cavity and the external cavity defined by the laser output facet and the output facet of the wavelength conversion device are matched, wavelength instabilities may be eliminated even when the output facet of the wavelength conversion device has significant reflectivity coefficients. As an example and not a limitation, the DBR laser diode 110 in one embodiment experiences sequential mode hops having an average amplitude of less than about 0.5 nm during lasing operation.

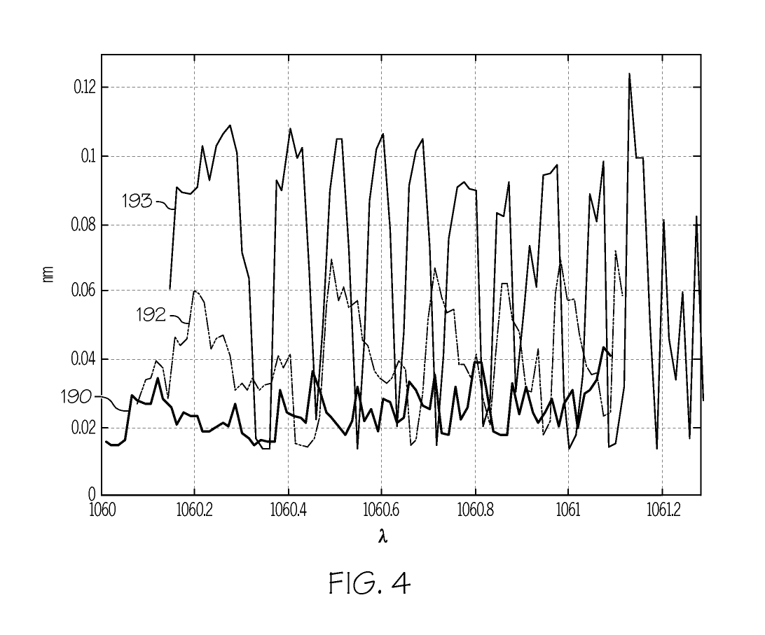

Referring now to FIG. 4, the cavity matching effect was experimentally verified. The experiment included coupling a 1060 nm DBR laser diode to a fiber that had no wedge at the input facet (i.e., a straight input facet) so as to introduce 4% feedback into the laser. The external cavity length was adjusted by coupling the fiber to a reflectometer measuring the distance between the fiber input facet and the DBR laser diode output facet. The laser stability was determined by measuring the spectral width as the DBR laser diode was modulated under a fast return-to-zero (RZ) modulation scheme and received gradually increasing average gain current. Curve 190 depicts the result when the external cavity was aligned for the cavity matching condition (L=9.36 mm), curve 192 depicts the result when the external cavity was misaligned from the cavity matching condition by about 150 microns, and curve 194 depicts the result when the external cavity has the same length as from the laser diode to an input facet of the PPLN crystal in a Corning G1000 laser package. As may be seen from the results provided in FIG. 4, the standard deviation in the cavity matching condition (curve 190) remains smaller than when the cavities are not matched.

Referring once again to FIG. 1, the waveguide 122 of the wavelength conversion device 120 is proximity coupled to the laser output facet 117, meaning that the waveguide 122 is positioned in close proximity to the DBR laser diode 110 such that input facet 121 of the wavelength conversion device 120 is separated from the laser output facet 117 by a gap L_{G}. In one embodiment, the gap L_{G} is approximately zero as the input facet 121 of the wavelength conversion device 120 may abut the laser output facet 117. The gap L_{G} should be small enough to ensure that mode hopping of the DBR laser diode 110 is minimized and the DBR laser diode 110 operates in a stable manner. In one embodiment, the gap L_{G} is less than about 10 μm.

To obtain a cavity matching condition, the optical length of the waveguide 122 within the wavelength conversion device 120 (or other optical component) should be an integer multiple of the optical path length of the laser cavity L_{LC}. In this condition, the output facet 123 of the waveguide 122 (or wavelength conversion device 120) is positioned such that the output facet 123 of the waveguide 122 defines an external cavity having an optical path length L_{EC} extending from the reflective laser output facet 117 to the output facet 123 of the waveguide 122, wherein the external optical path length L_{EC} is an integer multiple of the optical path length of the laser cavity L_{LC} (i.e., a cavity matching condition). In one embodiment, the waveguide optical length is substantially equal to twice the laser optical path length within the laser cavity L_{LC}.

The optical length of the waveguide should be as close to an integer multiple of the optical path length of the laser cavity L_{LC} as possible. The optical length of the waveguide and the distance of the waveguide from the DBR laser diode should be such that wavelength fluctuations of the IR output beam due to mode hopping are within a frequency conversion bandwidth of the waveguide and wavelength conversion device when the waveguide is incorporated into a frequency-converting system. In one embodiment, the optical length of the waveguide is such that wavelength fluctuations due to mode hopping are less than ±0.05 nm. To achieve stable operation of the DBR laser diode, in one embodiment the optical length of the waveguide is within about 500 μm of an integer multiple of the laser optical path length within the laser cavity L_{LC}.

The output facet 123 of the waveguide 122 should be the dominant reflective surface such that the external cavity is defined by the laser output facet 117 and the output facet 123. Therefore, the output facet 123 of the waveguide 122 should be more reflective to the IR output beam of the DBR laser diode 110 than the input facet 121 as well as the laser output facet 117. In one embodiment, the output facet 123 of the wavelength conversion device 120 has a reflectivity that is higher than the reflectivity of the laser output facet 117 combined with the input facet 121 of the wavelength conversion device 120.

In one particular embodiment, the reflectivities of the laser output facet 117, the input facet 121 and the output facet 123 satisfy the following relationship:

R₃>R₁+R₂+2(R₁*R₂)^{0.5}, Eq. (3),

where R₁ is a reflectivity of the reflective laser output facet, R₂ is a reflectivity of the input facet of the waveguide, and R₃ is a reflectivity of the output facet of the waveguide.

As an example and not a limitation, in one embodiment R₁ is about 0.5%, R₂ is about 0.1%, and R₃ is about 15%. It should be understood that other reflectivities satisfying Eq. (3) may be utilized. To achieve these reflectivities, the laser output facet 117 and the input facet 121 of the waveguide 122 (or wavelength conversion device 120) may be coated with an anti-reflectivity coating. For example, an anti-reflectivity coating may be provided to the input facet 121 such that the input facet has a reflectivity of less than about 0.3%. The output facet 123 may or may not be coated with an anti-reflective coating to achieve the desired reflectivity.

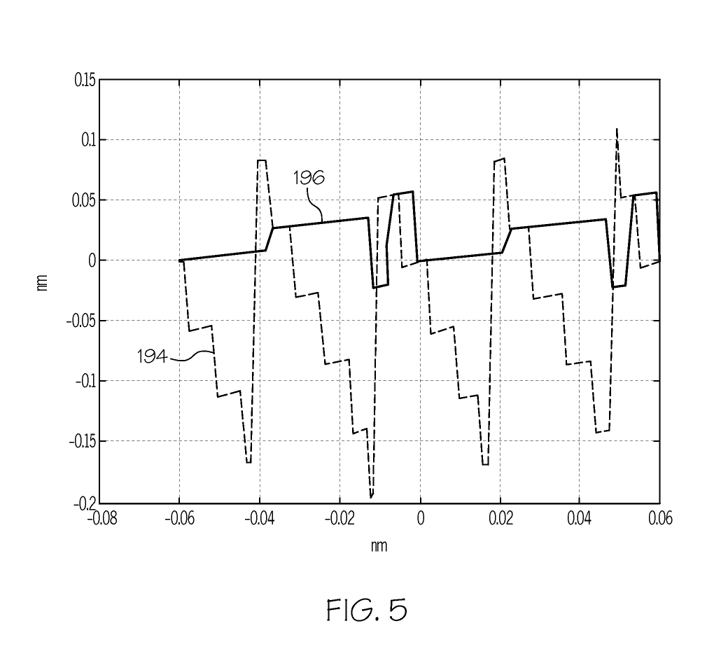

FIG. 5 is a plot of the wavelength of the extended cavity mode with the highest round trip reflectivity as a function of the diode cavity resonance shift. The plot is a simulation of a laser wherein a DBR laser diode and a SHG crystal are proximity coupled. The SHG crystal has straight facets. The distance from the DBR laser diode to the SHG crystal is a few microns and the optical path length of the SHG crystal is twice the laser cavity within DBR laser diode. However, to simulate the SHG crystal length tolerance that occurs during fabrication, 0.5 mm path length was added to the SHG crystal.

Curve 194 is the result of the simulation when assuming that the dominating mirror is the laser output facet of DBR laser diode, wherein r1/r2/r3=2.5%/0.1%/0.5%, respectively. Curve 196 was calculated assuming that the external cavity was dominated by the output facet of the SHG crystal, wherein r1/r2/r3=0.5%/0.1%/15%, respectively. As can be seen, the second case results in mode hops that remain of small amplitude although the cavity matching condition is wrong by half a millimeter. Accordingly, high reflectivity factors on the output facet of the SHG crystal may help to relax the manufacturing and alignment tolerances of the wavelength conversion device to achieve stable lasing operation.

It is to be understood that the preceding detailed description is intended to provide an overview or framework for understanding the nature and character of the subject matter as it is claimed. It will be apparent to those skilled in the art that various modifications and variations can be made to the embodiments described herein without departing from the spirit and scope of the invention. Thus, it is intended that the present invention cover the modifications and variations of this invention provided they come within the scope of the appended claims and their equivalents.

It is noted that terms like “preferably,” and “typically,” when utilized herein, are not intended to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. Further, it is noted that reference to a value, parameter, or variable being a “function of” another value, parameter, or variable should not be taken to mean that the value, parameter, or variable is a function of one and only one value, parameter, or variable.

For the purposes of describing and defining the present invention it is noted that the terms “substantially,” “approximately” and “about” are utilized herein to represent the inherent degree of uncertainty that may be attributed to any quantitative comparison, value, measurement, or other representation. The term “substantially” is also utilized herein to represent the degree by which a quantitative representation. e.g., “substantially above zero,” varies from a stated reference, e.g., “zero,” and should be interpreted to require that the quantitative representation varies from the stated reference by a readily discernable amount.

What is claimed is:

1. An optical source comprising a laser source and a waveguide wherein:
the laser source comprises a laser cavity having a laser optical path length extending from a DBR grating to a reflective laser output facet, and the laser source emits an output beam at a fundamental wavelength;
the waveguide comprises an input facet and an output facet, the waveguide extending along a waveguide optical length from the input facet of the waveguide to the output facet of the waveguide;
the input facet and the output facet of the waveguide are approximately normal with respect to an optical path of the output beam;
the waveguide and the laser source are proximity coupled; and
the waveguide optical length is an integer multiple of the laser optical path length.

2. The optical source of claim 1, wherein the waveguide optical length is such that an external cavity having an optical path length extending from the reflective laser output facet to the output facet of the waveguide is in a cavity matching condition with respect to the laser cavity.

3. The optical source of claim 1, wherein the waveguide comprises a frequency-converting waveguide of a wavelength conversion device that converts the output beam emitted by the laser source into a frequency-converted output beam having a converted wavelength that is shorter than the fundamental wavelength.

4. The optical source of claim 3, wherein the waveguide optical length is such that wavelength fluctuations of the output beam due to mode hopping are within a frequency conversion bandwidth of the wavelength conversion device.

5. The optical source of claim 3, wherein the waveguide optical length is such that the frequency-converted output beam experiences wavelength fluctuations that are less than ±0.05 nm.

6. The optical source of claim 1, wherein the waveguide optical length is within ±500 μm of an integer multiple of the laser optical path length within the laser cavity.

7. The optical source of claim 1, wherein the waveguide optical length is substantially equal to twice the laser optical path length within the laser cavity.

8. The optical source of claim 1, wherein the input facet of the waveguide is coated with an anti-reflectivity coating.

9. The optical source of claim 8, wherein the anti-reflectivity coating on the input facet of the waveguide provides a reflectivity that is less than about 0.3%.

10. The optical source of claim 1, wherein the output facet of the waveguide has a reflectivity that is higher than a reflectivity of the reflective laser output facet of the laser source.

11. The optical source of claim 1, wherein the output facet of the waveguide has a reflectivity of about 15%.

12. The optical source of claim 11, wherein the output facet is not coated with an anti-reflectivity coating.

13. The optical source of claim 1, wherein:
R₃>R₁+R₂+2(R₁*R₂)^{0.5},
where:
R₁ is a reflectivity of the reflective laser output facet of the laser source,
R₂ is a reflectivity of the input facet of the waveguide, and
R₃ is a reflectivity of the output facet of the waveguide.

14. The optical source of claim 13, wherein:
R₁ is about 0.5%;
R₂ is about 0.1%; and
R₃ is about 15%.

15. The optical source of claim 13, wherein the output facet is not coated with an anti-reflectivity coating.

16. The optical source of claim 1, wherein the input facet of the waveguide is within about 10 μm of the reflective laser output facet of the laser source.

17. An optical source comprising a laser source and a wavelength conversion device, wherein:
the laser source comprises a laser cavity having a laser optical path length extending from a DBR grating to a reflective laser output facet, and the laser source emits an output beam at a fundamental wavelength;
the wavelength conversion device comprises an input facet, an output facet, and a waveguide extending from the input facet of the wavelength conversion device to the output facet of the wavelength conversion device;
the input facet and the output facet of the wavelength conversion device are approximately normal with respect to an optical path of the output beam;
the output facet of the wavelength conversion device has a reflectivity that is higher than a reflectivity of the reflective laser output facet of the laser source;
the wavelength conversion device and the laser source are proximity coupled;
a wavelength conversion device optical length extending along the waveguide is within about 500 μm of an integer multiple of the laser optical path length; and
the wavelength conversion device converts the output beam emitted by the laser source into a frequency-converted output beam having a converted wavelength that is shorter than the fundamental wavelength.

18. The optical source of claim 17, wherein the waveguide optical length is within ±500 μm of an integer multiple of the laser optical path length within the laser cavity.

19. An optical source comprising a laser source and a wavelength conversion device, wherein:
the laser source comprises a laser cavity having a laser optical path length extending from a DBR grating to a reflective laser output facet, and the laser source emits an output beam at a fundamental wavelength;
the wavelength conversion device comprises an input facet, an output facet, and a waveguide extending from the input facet of the wavelength conversion device to the output facet of the wavelength conversion device;
the input facet and the output facet of the wavelength conversion device are approximately normal with respect to the optical path of the output beam;
the reflective laser output facet, the input facet of the wavelength conversion device, and the output facet of the wavelength conversion device have a reflectivity such that:
R₃>R₁+R₂+2(R₁*R₂)^{0.5},
where:
R₁ is a reflectivity of the reflective laser output facet of the laser source,
R₂ is a reflectivity of the input facet of the waveguide, and
R₃ is a reflectivity of the output facet of the waveguide;
the wavelength conversion device and the laser source are proximity coupled;
a wavelength conversion device optical length extending along the waveguide is an integer multiple of the laser optical path length; and
the wavelength conversion device converts the output beam emitted by the laser source into a frequency-converted output beam having a converted wavelength that is shorter than the fundamental wavelength.

20. The optical source of claim 19, wherein the waveguide optical length is within ±500 μm of an integer multiple of the laser optical path length within the laser cavity.
